(19) United States
(12) Patent Application Publication
(10) Pub. No.: US 2008/0043730 A1
(43) Pub. Date: Feb. 21, 2008

(54) INTERGRATED INTERFACE DEVICE

(75) Inventor: Dong Soo Ann, Seoul (KR)

Correspondence Address: LUCAS & MERCANTI, LLP, 475 PARK AVENUE SOUTH, 15TH FLOOR, NEW YORK, NY, 10016, US

(73) Assignee: NAMOO I&C., LTD., Seoul (KR)

(21) Appl. No.: 11/839,836

(22) Filed: Aug. 16, 2007

(30) Foreign Application Priority Data
Aug. 17, 2006 (KR) 10-2006-0077659

(51) Int. Cl. H04L 12/50

(52) U.S. Cl. 370/360

(57) ABSTRACT

Disclosed herein is an integrated interface device. The integrated interface device includes an input terminal configured to have a plurality of input ports and to receive data from the input ports, an interface unit for processing data input from each of the input ports, according to a corresponding interface algorithm, an output terminal configured to have a plurality of output ports and to output data, input from the interface unit, to a specific output port, an algorithm creation/change unit for creating or changing an interface algorithm required for the interface unit, a key input unit for generating a key signal for creating or changing an interface algorithm, a display unit for displaying image information for creating or changing an interface algorithm, and a control unit for controlling the algorithm creation/change unit and the display unit in response to the key signal input from the key input unit.

### CROSS REFERENCE TO RELATED APPLICATIONS

The present disclosure relates to subject matter contained in priority Korean Application No. 10-2006-0077659, filed on 17 Aug. 2006 which is herein expressly incorporated by reference in its entirety.

### BACKGROUND OF THE INVENTION

1. Field of the Invention

The present invention relates, in general, to an integrated interface device and, in particular, to an integrated interface device designed to seamlessly interconnect a host of heterogeneous devices found in large number of manufacturing plants around the globe.

2. Description of the Related Art

FIG. 1 provides a high-level schematic diagram illustrating composition of a conventional interface system used to connect heterogeneous devices in typical manufacturing plants.

As shown in FIG. 1, the conventional interface system is comprised of data production devices (10), that is those equipment or instruments installed in a factory, of data analysis devices (30) that analyses the data delivered from data production devices (10), and of interface devices (20) that interconnects the data analysis devices (10) and corresponding data production devices (10).

In the aforementioned system, the data production devices (10) may well be a variety of sensors for gathering production environmental factors, such as temperature of the factory and operation status of an equipment as in Revolutions Per Minute (RPM), and Programmable Logic Controllers (PLC) or Distributed Control Systems (DCS) that commands and controls manufacturing equipment in the factory, and storage devices that keep track of raw-material inventories, work-in-process and production data and more.

The data analysis devices (30) may well be computers in which enterprise-wide applications as Enterprise Resource Planning (ERP) and Supply Chain Management (SCM) solutions are installed. Furthermore, the data analysis devices (30) may be monitoring devices that display the analyzed output(data) from the above-mentioned enterprise applications or collected data from various sensors around the factory, in a intuitive, graphical manner.

An inter-connector among heterogeneous devices, the interface devices (20) convert into user-defined formats the data from the data production devices (10), and if required, process the data according to the predetermined algorithms. The conversion and process results are delivered to the data analysis devices (30) for display.

The conventional interface systems between heterogeneous devices, however, fall short in that they impose limited re-use and more often than not require additional development of new separate interface devices whenever inter-devices connection scheme changes. For an instance, to have an integrated view of the heretofore separate PLC and DCS datasets, re-use of the existing interface devices is rather prohibitive, if not out of the question.

Furthermore, installation of new data production devices or data analysis devices adds its own layer of interfaces eventually resulting in a so-called “spaghetti interfacing environment” in which the level of complexity amongst device interfaces are such that effective and timely management (addition, expansion, modification, operation and removal) of interfaces extremely difficulty, if not impossible.

### SUMMARY OF THE INVENTION

Accordingly, the present invention has been made keeping in mind the above problems occurring in the prior art, and an object of the present invention is to provide an integrated interface device that provides various interface modes for interconnecting heterogeneous devices and allows interface modes to be created and changed.

In order to accomplish the above object, the present invention provides an integrated interface device, including an input terminal configured to have a plurality of input ports and to receive data from the input ports; an interface unit for processing data, input from each of the input ports, according to a corresponding interface algorithm; an output terminal configured to have a plurality of output ports and to output data input from the interface unit to a specific output port; an algorithm creation/change unit for creating or changing an interface algorithm required for the interface unit; a key input unit for generating a key signal for creating or changing an interface algorithm; a display unit for displaying image information for creating or changing an interface algorithm; and a control unit for controlling the algorithm creation/change unit and the display unit in response to the key signal input from the key input unit.

The interface unit includes an extraction module for extracting a specific region from data input from each of the input ports of the input terminal; a format conversion module for converting a format of the data input from the extraction module into a specific format; a processing module for processing the data input from the format conversion module; and a sink module for converting a format of the data, input from the processing module, into a specific format and outputting the data to a specific output port of the output terminal. Here, the data format obtained by the format conversion module is a Java object format.

The interface unit comprises a first extraction module for extracting a specific region from data input from each of the input ports of the input terminal; a first format conversion module for converting a format of data input from the first extraction module into a specific format; a first processing module for processing data input from the first format conversion module; an Extensible Markup Language (XML) conversion module for converting data, input from the first processing module, into XML format; a modification module for modifying XML data input from the XML conversion module; a second extraction module for extracting a specific region from XML data input from the processing module; a second format conversion module for converting the format of XML data input from the second extraction module into a specific format; a second processing module for processing data input from the second format conversion module; and a sink module for converting a format of data input from the second processing module into a specific format, and outputting the data to a specific output port of the output terminal. Here, the data format obtained by the first format conversion module and the second format conversion module is a Java object format.

Additionally, the present invention provides a computer-readable recording medium in which modules constituting the interface unit are stored.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram showing the schematic construction of the conventional interface system used between heterogeneous devices;

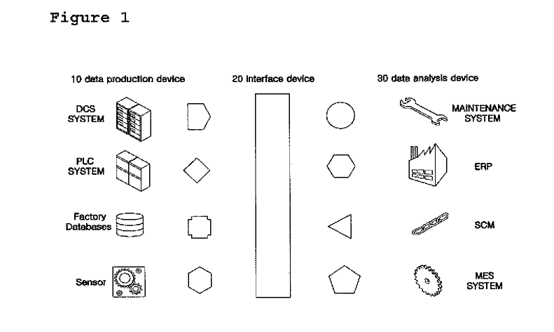

FIG. 2 is a block diagram of an integrated interface device according to an embodiment of the present invention;

FIG. 3 is a functional block diagram of the interface unit shown in FIG. 2;

FIG. 4 is another functional block diagram of the interface unit shown in FIG. 2; and

FIG. 5 is a view diagram schematically showing the various interface algorithms of the integrated interface device according to an embodiment of the present invention.

### DESCRIPTION OF THE PREFERRED EMBODIMENTS

Reference now should be made to the drawings, in which the same reference numerals are used throughout the different drawings to designate the same or similar components.

An integrated interface device will now be described in detail in connection with preferred embodiments of the present invention, with reference to the accompanying drawings.

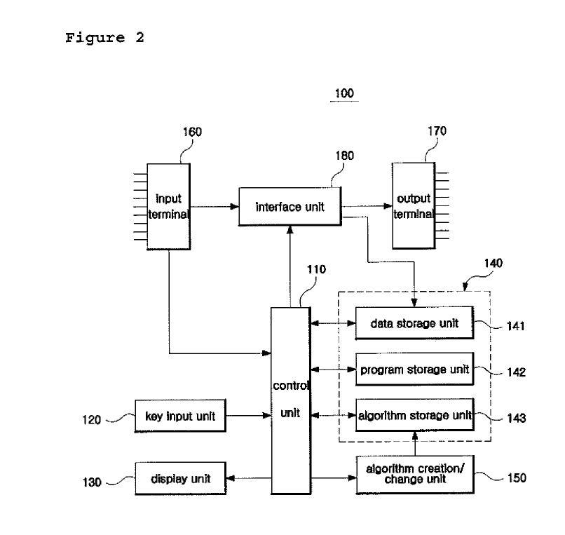

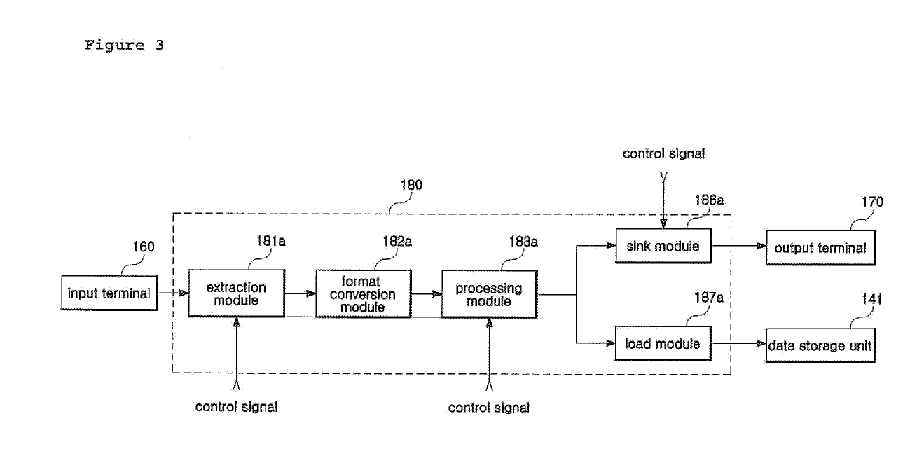

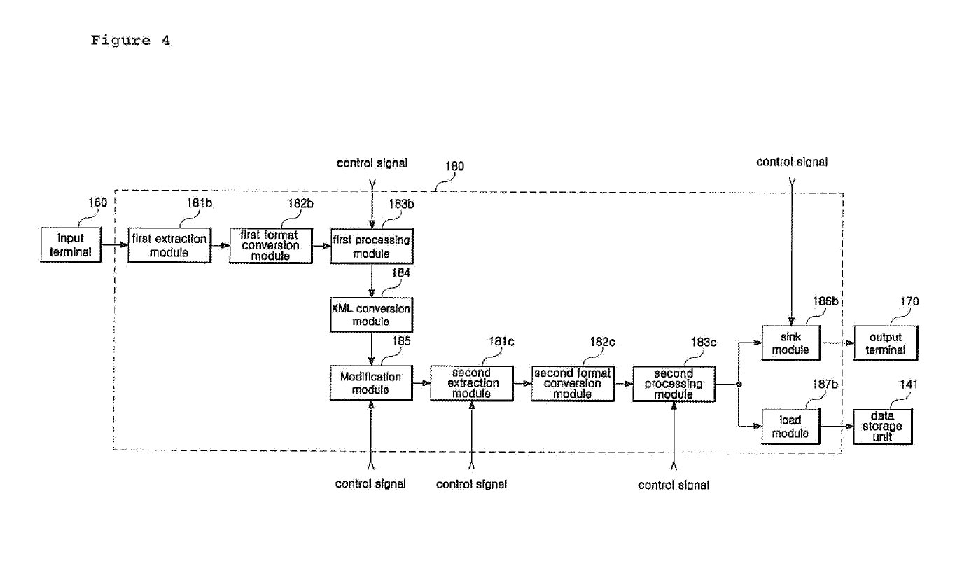

FIG. 2 is a block diagram of an integrated interface device 100 according to an embodiment of the present invention. FIG. 3 is a functional block diagram of the interface unit 180 shown in FIG. 2. FIG. 4 is another functional block diagram of the interface unit 180 shown in FIG. 2.

The integrated interface device 100 according to the present invention, as shown in FIG. 2, includes an input terminal 160 configured to have a plurality of input ports and connected to various data production devices through the input ports; an interface unit 180 for processing data, input from the input terminal 160, according to a corresponding interface algorithm (hereinafter abbreviated to an “algorithm”); an output terminal 170 configured to have a plurality of output ports, connected to various data analysis devices through the output ports, and configured to output data, input from the interface unit 180, to a data analysis device connected to a specific output port; an algorithm creation/change unit 150 for creating or changing an interface algorithm; storage 140 configured to include a data storage unit 141 for storing data processed according to the above-described algorithm, a program storage unit 142 for storing an operating system that supports a Graphic User Interface (GUI) environment, and a Java virtual machine that analyzes data written in the Java language and executes the data in a manner suitable for the operating system, and an algorithm storage unit 143 that stores interface algorithms; a display unit 130 for performing image processing on various pieces of data and then displaying the data; a key input unit 120 for generating various key signals, and a control unit 110 for integrally controlling the above-described elements.

In the above-mentioned construction, when data is received through a certain input port, the input terminal 160 outputs a unique code, indicating the input port, to the control unit 110. Accordingly, the control unit 110 detects an algorithm, corresponding to the unique code, via the algorithm storage unit 143, and outputs a control signal, corresponding to the detected algorithm, to the interface unit 180.

The construction of the functional modules of the interface unit 180, as shown in FIG. 3, includes an extraction module 181a for extracting a specific region from data, input from the input terminal 160, based on a corresponding algorithm, that is, based on a control signal input from the control unit 110; a format conversion module 182a for converting the format of the data, input from the extraction module 181a, into a Java object format; a processing module 183a for processing the Java object format data, input from the format conversion module 182a, based on a control signal input from the control unit 110; a sink module 186a for converting the Java object format data, input from the processing module 183a, into a specific format based on a control signal input from the control unit 110, and outputting resulting data to a specific output port; and a load module 187a for storing data, input from the processing module 183a, in the data storage unit 141.

Meanwhile, another construction of the functional modules of the interface unit 180, as shown in FIG. 4, includes a first extraction module 181b for extracting a specific region from data, input from the input terminal 160, based on a corresponding algorithm, that is, a control signal input from the control unit 110; a first format conversion module 182b for converting the format of the data, input from the first extraction module 181b, into a Java object format; a first processing module 183b for processing the data, input from the first format conversion module 182b, based on a control signal input from the control unit 110; an Extensible Markup Language (XML) conversion module 184 for converting the Java object format data, input from the first processing module 183b, into XML format; a modification module 185 for modifying the XML data, input from the XML conversion module 184, based on a control signal input from the control unit 110; a second extraction module 181c for extracting a specific region from the XML data, input from the modification module 185, based on a control signal input from the control unit 110; a second format conversion module 182c for converting the format of the XML data, input from the second extraction module 181c, into a Java object format; a second processing module 183c for processing the Java object format data, input from the second format conversion module 182c, based on a control signal input from the control unit 110; a sink module 186b for converting the Java object format data, input from the second processing module 183c, into a specific format based on a control signal input from the control unit 110, and outputting resulting data to a specific output port; and a load module 187b for storing the Java object format data, input from the second processing module 183c, in the data storage unit 141.

In greater detail, the processing modules 183a, 183b, and 183c perform operations such as unit conversion, four fundamental operations, filtering, and conditional branching.

The modification module 185 is not significantly different from the above-described modules, but performs more complicated operations than the processing modules 183a, 183b, and 183c. The sink modules 186a and 186b convert the formats of data, input from the processing modules 183a and 183c, into the data formats of the data analysis devices to which the data will be input.

Meanwhile, the control unit 110 controls the display unit 130 so that the display unit 130 displays image information that is used for the creation and change of an algorithm. Furthermore, the control unit 110 controls the algorithm creation/change unit 150 so that the algorithm creation/change unit 150 creates a new algorithm to be stored in the algorithm storage unit 143 or changes an algorithm stored in the algorithm storage unit 143 based on a key signal for the creation/change of an algorithm, which is input from the key input unit 120.

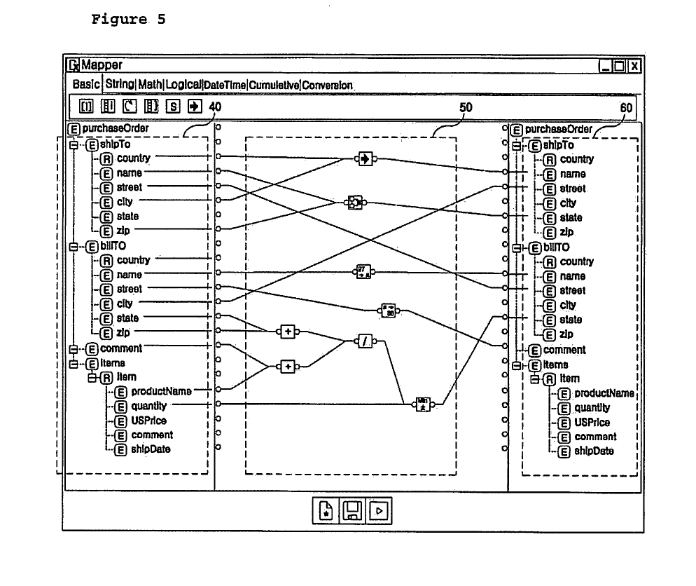

FIG. 5 is a view diagram schematically showing the various interface algorithms of the integrated interface device according to an embodiment of the present invention. Here, reference numeral 40 designates the names of respective data production devices connected to the input terminal 160, reference numeral 60 designates the names of respective data analysis devices connected to the output terminal 170, and reference numeral 50 designates icons configured to indicate respective interface algorithms. In particular, these icons contain data processing or modification rules.

That is, as shown in FIG. 5, the interface device 100 of the present invention provides a user with a GUI environment in which various interface modes are created or changed.

According to the integrated interface device of the present invention, various interface algorithms for interconnecting heterogeneous devices can be provided. Furthermore, when the method of connection between heterogeneous devices is changed, a corresponding interface algorithm is newly created or changed, so that it is not necessary to develop a new interface device, and the management of an interface system is made easy.

Moreover, a GUI environment, which enables a user to easily create or change interface algorithms, is provided.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An integrated interface device, comprising:
an input terminal configured to have a plurality of input ports and to receive data from the input ports;
an interface unit for processing data, input from each of the input ports, according to a corresponding interface algorithm;
an output terminal configured to have a plurality of output ports and to output data input from the interface unit to a specific output port;
an algorithm creation/change unit for creating or changing an interface algorithm required for the interface unit;
a key input unit for generating a key signal for creating or changing an interface algorithm;
a display unit for displaying image information for creating or changing an interface algorithm; and
a control unit for controlling the algorithm creation/change unit and the display unit in response to the key signal input from the key input unit.

2. The integrated interface device according to claim 1, wherein the interface unit comprises:
an extraction module for extracting a specific region from data input from each of the input ports of the input terminal;
a format conversion module for converting a format of the data input from the extraction module into a specific format;
a processing module for processing the data input from the format conversion module; and
a sink module for converting a format of the data, input from the processing module, into a specific format and outputting the data to a specific output port of the output terminal.

3. The integrated interface device according to claim 2, wherein the data format obtained by the format conversion module is a Java object format.

4. The integrated interface device according to claim 1, wherein the interface unit comprises:
a first extraction module for extracting a specific region from data input from each of the input ports of the input terminal;
a first format conversion module for converting a format of data input from the first extraction module into a specific format;
a first processing module for processing data input from the first format conversion module;
an Extensible Markup Language (XML) conversion module for converting data, input from the first processing module, into XML format;
a modification module for modifying XML data input from the XML conversion module;
a second extraction module for extracting a specific region from XML data input from the processing module;
a second format conversion module for converting a format of XML data input from the second extraction module into a specific format;
a second processing module for processing data input from the second format conversion module; and
a sink module for converting a format of data input from the second processing module into a specific format, and outputting the data to a specific output port of the output terminal.

5. The integrated interface device according to claim 4, wherein the data format obtained by the first format conversion module and the second format conversion module is a Java object format.

6. A computer-readable recording medium in which modules constituting the interface unit according to claim 2 is stored.

7. A computer-readable recording medium in which modules constituting the interface unit according to claim 3 is stored.

8. A computer-readable recording medium in which modules constituting the interface unit according to claim 4 is stored.

9. A computer-readable recording medium in which modules constituting the interface unit according to claim 5 is stored.
